(19) United States
(12) Patent Application Publication
(10) Pub. No.: US 2017/0109965 A1
(43) Pub. Date: Apr. 20, 2017

(54) Method and Apparatus for Social Gaming Storefront

(71) Applicant: Saber Gaming Technologies, LLC, Maplewood, NJ (US)

(72) Inventor: Matthew Karch, Short Hills, NJ (US)

(73) Assignee: SABER GAMING TECHNOLOGIES, LLC, Maplewood, NJ (US)

(21) Appl. No.: 14/886,670

(22) Filed: Oct. 19, 2015

(51) Int. Cl. G07F 17/32; A63F 13/70

(52) U.S. Cl. CPC G07F 17/3225; A63F 13/70; G07F 17/3286; G07F 17/3255

(57) ABSTRACT

A social gaming storefront allows users to play various branded games, such as virtual slot machines, in order to collect reward points which may be used to purchase products and services from a related business. Branded games are games that contain images or indicia associated with a business or entertainment property. Users can select a branded game to play using play chips awarded to a user or purchased by a user. Users' game play can be posted to social networks and users can invite others to play.

### BACKGROUND

The present disclosure relates generally to social gaming, and more particularly to social gaming storefronts.

Businesses use advertising in order to persuade people to purchase the business's product and/or services. Various forms of advertising are used with varying degrees of success. Businesses often focus on a specific demographic for their advertising in order to target customers who the businesses think will be most likely to purchase their product. Businesses need to continually advertise to customers in order to keep the business on a customer's mind so that when the customer is ready to make a purchase, the customer purchases from the businesses that have advertised to them. Businesses also use advertising to keep customers returning. The returning customers, together with new customers, allow a business to maintain a high level of profit. Distinguishing a particular business is particularly important when many other businesses offer similar products and services. As such, businesses are typically interested in using anything that can be used to attract new customers and keep existing customers returning.

### SUMMARY

In one embodiment, a method for a social gaming storefront includes receiving a user request to play a game. A user is then presented with a plurality of branded games to play and input from the user is received selecting one of the plurality of branded games. The selected branded game is then presented to the user to play and user play is tracked. Reward points are awarded to the user related to a brand of the selected branded game based on the tracking. A user can request to purchase goods or services using reward points the user has accumulated. Bonus icons presented to a user randomly can be banked by the user and used with additional banked bonus icons to receive a prize. Game play information can be posted to a social network website associated with the user.

An apparatus and computer readable medium for a social gaming storefront is also described.

### BRIEF DESCRIPTION OF THE DRAWINGS

FIG. 1 shows depicts a social gaming storefront system according to one embodiment;

FIGS. 2A and 2B depict a flowchart of a method according to one embodiment; and

FIG. 3 depicts a high-level block diagram of a computer which can be used to implement a mobile user device, personal computer, and server.

### DETAILED DESCRIPTION

The present disclosure pertains to a social gaming storefront which allows users to play various branded games, such as virtual slot machines, in order to collect reward points which may be used to purchase products and services from a related business. A social gaming storefront comprises games branded in order to associate the game with a related business and/or entertainment property. A social gaming storefront allows users to play a variety of games and inform their friends of their gaming activities. Users can select a particular branded game to play from a plurality of branded games. The user can then play the particular branded game using play chips awarded to and/or purchased by the user. Users' can also invite others, such as friends or acquaintances, to play.

Branded games are games that contain one or more images, indicia, phrases, and/or concepts associated with a business or entertainment property such as products or services a business offers, and/or an actor, character, movie, television show, etc. For example, a virtual slot machine may be titled after a television show and have icons representing various characters from the television show on the rollers of the virtual slot machine. A card game may depict images related to a movie on the back of the cards. A bingo game may replace letters and/or numbers with characters, objects, or concepts related to a television show.

Branded games can include a variety of different types of games such as slot machine type games, card games (i.e. poker, black jack, etc.), board games, arcade games, etc. Branding of the game, in one embodiment, can be based on the type of game that is to be branded. For example, the backs of cards for a card game can contain various images associated with a particular business or entertainment property. In another example, a board game may have playing spaces that contain various images associated with a particular business or entertainment property.

A branded game typically focuses on one concept such as a business name or a movie. For example, a branded game may contain the name and logo of the business or movie. In one embodiment, a branded game is branded based on a theme. A branded game based on a theme typically includes more than just a name and logo. A branded game based on a theme can incorporate multiple concepts. For example, a branded game can be based on a theme such as a movie. In addition to the name and logo associated with the movie, one or more characters may be displayed as well. In addition, scenes, objects, or quotes from the movie may also be displayed. A theme can comprise a collection of images, indicia, phrases, and/or concepts associated with a particular business or entertainment property. In other embodiments, a branded game based on a theme may contain various images, indicia, phrases, and/or concepts associated with a plurality of businesses or entertainment properties.

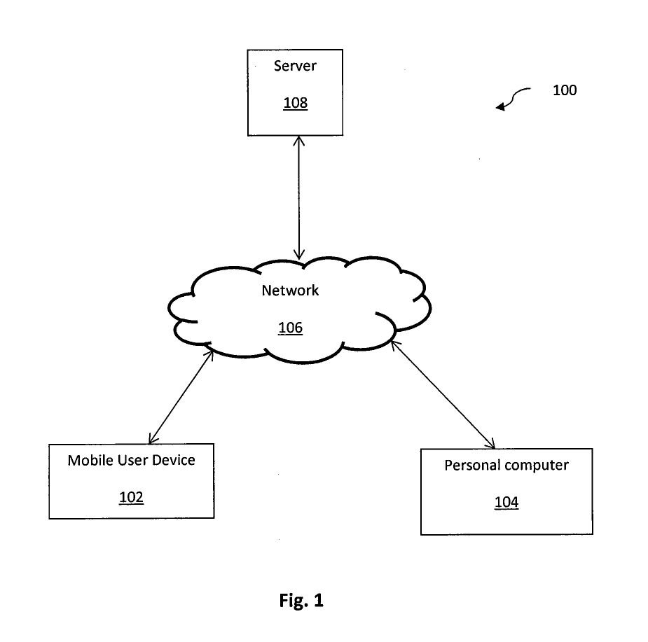

FIG. 1 shows social gaming storefront system 100 comprising mobile user device 102 and personal computer 104 in communication with server 108 via network 106. Mobile user device 102 can be any device capable of supporting an electronic game and communicating via network 104 with server 108. Mobile user device 102, in one embodiment, is a handheld device such as a smart phone or tablet computer. According to one embodiment, a program executed on mobile user device 102 allows a user to play a game.

Personal computer 104 is any type of computer capable of supporting an electronic game and communicating via network 104 with server 106. In one embodiment, personal computer 104 is a desktop computer but can be a laptop or other type of personal computer. According to one embodiment, a program executed on personal computer 104 allows a user to play a game.

Server 108, in one embodiment, is a computer but can be any device capable of communicating with mobile user device 102 and personal computer 104 via network 108 and facilitating game play via those devices. Network 106 can be any type of wired and/or wireless network supporting communication between devices such as mobile user device 102, personal computer 104, and server 108.

In one embodiment, a user plays a game, such as a virtual slot machine, via one of mobile user device 102 and personal computer 104. User game play is tracked and various chips, tokens, and/or bonuses are awarded based on user game play. Game play can be facilitated by an application or program downloaded and installed to one of mobile user device 102 and personal computer 104. The application or program facilitates game play by a user and also facilitates communication of information, such as gameplay information, between mobile user device 102, personal computer 104, and server 106 via network 106.

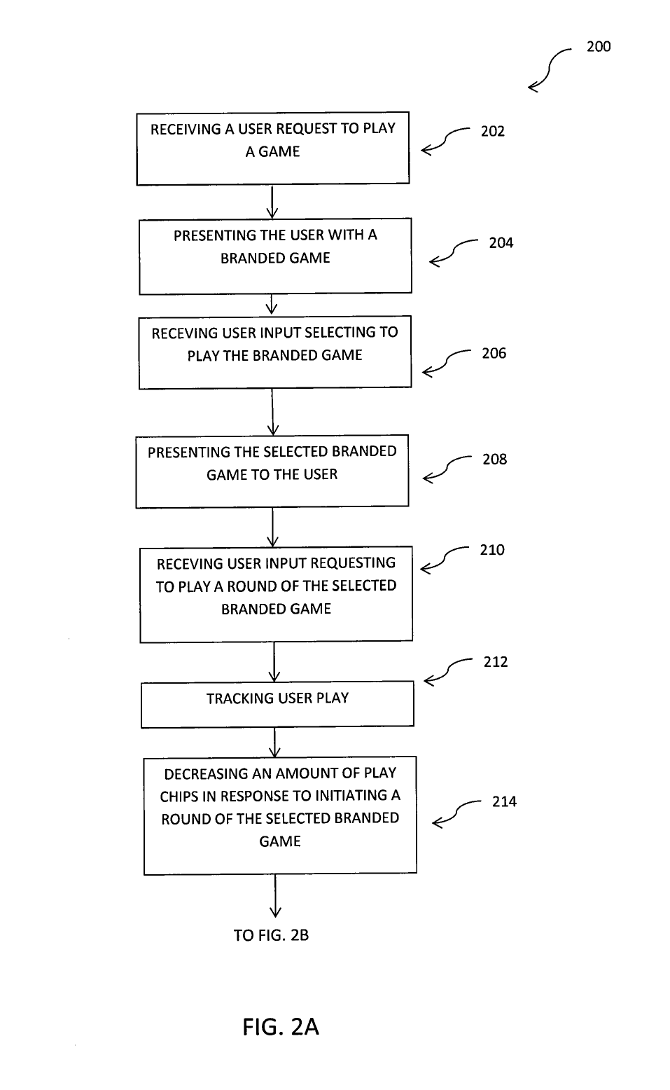

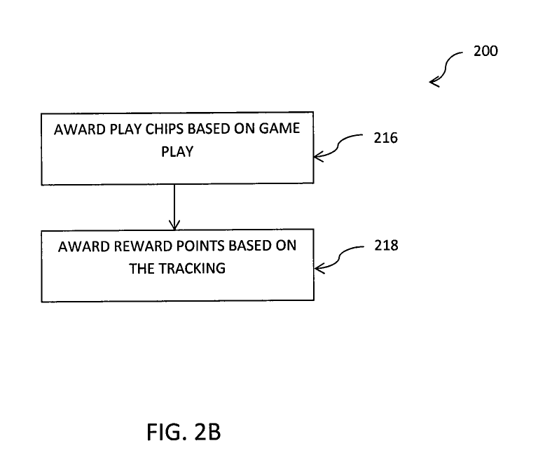

FIGS. 2A and 2B depict a flowchart of method 200 of social gameplay according to one embodiment in which method 200 is executed by a program running on one of mobile user device 102 and personal computer 104. At step 202, a user request to play a game is received. In one embodiment, the request is received from the user via input to mobile user device 102 or personal computer 104. In response to the user request to play a game, at step 204, the user is presented with a branded game that can be played. In one embodiment, the user is presented with a plurality of games to play. The particular games that are presented to the user may be based on one or more factors such as previous user game play, previous user selection of games, etc. At step 206, user input selecting the branded game is received. At step 208, the selected branded game is presented to the user to play. The user may then proceed to play the selected branded game.

At step 210, user input requesting to play a round of the selected branded game is received. In one embodiment, the request to play a round of the selected branded game initiates a round of play. For example, user input requesting to play a round of a selected branded game may initiate operation of a virtual slot machine causing an animation of rollers of the virtual slot machine to be shown spinning.

At step 212, tracking of user play begins. In one embodiment, various user play is tracked such as user performance (i.e., how well a user performs during game play based on factors such as number of wins and losses, total score, etc.) user pace (i.e., the amount of time a user takes to respond to certain stimulus such as responding to a question), and items or tokens awarded such as chips, free games, etc.

At step 214, in one embodiment, an amount of play chips associated with the user is decreased in response to initiating a round of the selected branded game. For example, operation of a round while playing a virtual slot machine can cost a user one or more play chips. As such, in response to initiating a round of the slot machine, the amount of a user's play chips may be decreased to reflect the cost of the round. In another embodiment, an amount of play chips associated with the user is not decreased in response to initiating a round of the selected branded game. As such, a user is not charged for playing a round as the cost of the round is zero.

At step 216, play chips are awarded to a user based on game play. For example, if a user is playing a virtual slot machine and a specific combination is shown by the rollers of the slot machine, a user is awarded play chips based on the specific combination shown by the rollers at the end of a round.

In addition to play chips, a user may be awarded a reward and/or reward points based on the tracked user play. At step 218, reward points are awarded to a user based on the tracking of step 210. For example, reward points may be awarded to a player daily for playing one or more games consecutively for a predetermined number of days. Reward points may also be awarded for other user play habits and/or randomly. In one embodiment, rewards are based on the brand of the branded game a user is playing. For example, a game branded to reflect a florist can award a user with reward points that may be used to purchase goods and/or services from the florist. For example, a player may be awarded a free bouquet of flowers in response to the player playing a slot machine in which a specific combination displayed on a virtual slot machine branded to reflect the florist.

Method 200 is described above as being executed by a program running on one of mobile user device 102 and personal computer 104. In one embodiment, information concerning user game play is transmitted from mobile user device 102 and/or personal computer 104 to server 108 for storage. Server 108 can be configured to communicate with servers associated with other entities such as businesses or social networks. In one embodiment, method 200 is executed on server 108 and game play data is transmitted to one of mobile device 102 and personal computer 104 for display to a user. In such embodiments, mobile user device 102 and personal computer 104 operate to present games to a user that are executed by server 108.

Users may be given an initial amount of play chips with which to play games. In one embodiment, users are given an amount of additional play chips on an hourly, daily, weekly, or other periodic basis. In one embodiment, a user is presented with a virtual wheel to spin and the user is given an amount of play chips based on an amount indicated by the virtual wheel after a spin. Users may also purchase play chips using currency. For example, a user may utilize a credit card, debit card, or other type of card or monetary account to purchase additional play chips. In addition, a user may be rewarded with play chips in response to certain actions or events. For example, a daily reward of play chips may increase each consecutive day a user plays one or more games. A user may also be rewarded with play chips randomly or in response to certain actions, such as a user referring one or more friends or acquaintances to play games.

In one embodiment, a user plays a game or a round of a game for one play chip. In some games, a user can place a bet using one or more play chips. For example, a user playing a branded slot machine may select a bet from a minimum bet (e.g., 1 play chip) to a maximum bet (e.g., 5 play chips). The amount of play chips awarded to a user for winning a bet can be multiplied by the number of play chips the user bet.

In one embodiment, user play is tracked in order to reward players for playing. User play can be tracked using one or more factors such as number of log ins, number of games played, number of consecutive days a user has logged in or played games, number of rounds played, etc. Rewards based on user play can take a significant amount of time investment from users. For example, a user may be rewarded with a free dinner at a restaurant associated with a particular branded game (e.g., a game branded using the restaurant name, logo, etc.) after several months of game play on the particular branded game. In one embodiment, the amount of play chips awarded to a player on a periodic basis can be based on a user achieving various amounts of game play time. In addition, rewards and payouts for winning games or rounds of a game can be increased based on an amount of time a user has played a game or for other achievements such as high scores.

In one embodiment, a user is presented with a bonus game in response to an occurrence in a game. Bonus games may also be presented to a user randomly or in response to certain milestones such as specific scores. A bonus game is a game different from the game the user is playing and typically awards the user with additional rewards for achievements in the bonus game. A bonus game can be branded in a manner similar to the branded game the user is playing. For example, a slot machine branded based on a television show may have a bonus game branded based on a particular episode of the television show. Bonus games can be any time of game but games that typically take a few minutes to play or less are used as bonus games. For example, a bonus game may require a user to uncover an icon hidden among various other icons. In one embodiment, a bonus game consists of allowing a user to choose from a plurality of icons. A user selects one of the plurality of icons to determine if the user has won something.

In one embodiment, a bonus icon is randomly presented to a user while the user is playing a branded game. For example, a user may be presented with a yellow rose on a wheel of a virtual slot machine. A user may bank this bonus icon to be used with other bonus icons to receive a prize. For example, a user may be required to collect ten yellow rose bonus icons before the user is eligible to receive a prize.

In one embodiment, a variety of branded games are available for the user to play. A user can alternatively be presented with a single branded game to game to play and require the user to complete certain requirements in order for the user to unlock additional branded games to play. For example, a user may only be allowed to play a branded game associated with a florist before being allowed to play a branded game associated with a motorcycle manufacturer after having played the branded game associated with the florist for a certain length of time.

In one embodiment, a daily jackpot may be awarded to one or more users. The daily jackpot can consist of a reward having a value higher than typical awards and be given to one or more users selected at random.

Rewards can be provided in one of a variety of forms including coupons, discounts, play chips, etc. In one embodiment, play chips can be traded for coupons or discounts. For example, a user can request a purchase, via mobile user device 102 or personal computer 102, using reward points the user has accumulated. In response, server 108 can facilitate the purchase by the user and decrease an amount of the user's reward points based on the purchase. In one embodiment, a purchase is facilitated by reducing an amount of the user's reward points in connection with sending the user a coupon for a product or service. Coupons and discounts can be time sensitive so that a user must redeem the coupon use the discount within a specified period of time or before a certain date. In one embodiment, coupons, discounts, and other rewards can be placed in a virtual wallet associated with a user for use at a later date.

In one embodiment, information related to user game play may be posted to a website, such as a social networking website the user is associated with and/or has an account. For example, a user's new high score may cause information concerning the score to be transmitted to a social networking website. A post on the social networking website may then be displayed indicating that the user has achieved a new high score in a specific game. The post may also contain information indicating how others viewing the post can play the game. For example, the post may contain a link to download the game. In one embodiment, a program or application executed to present the branded game to the user is capable of accessing a user's information from a social networking website of which the user is a member. The information from the social networking website can be used to generate reminders presented to a user while selecting or playing a branded game. The reminders can relate to upcoming special occasions, anniversaries, birthdays, etc. The reminders can include suggestions for products a user may purchase for a person identified as someone the user knows based on information from the social network website. A user can also select to send someone an e-card. In one embodiment, the e-card can be selected from a plurality of e-cards for a variety of occasions. The e-card can include a link which allows the recipient to play a game in a manner similar to the manner in which a user plays branded games as previously described.

In one embodiment, a branded game is associated with a particular business and links to a website of the business are presented to a user while selecting and/or playing a branded game. Users can select a link to be directed to the related business's website in order to view the goods and/or services the business offers and to make purchases.

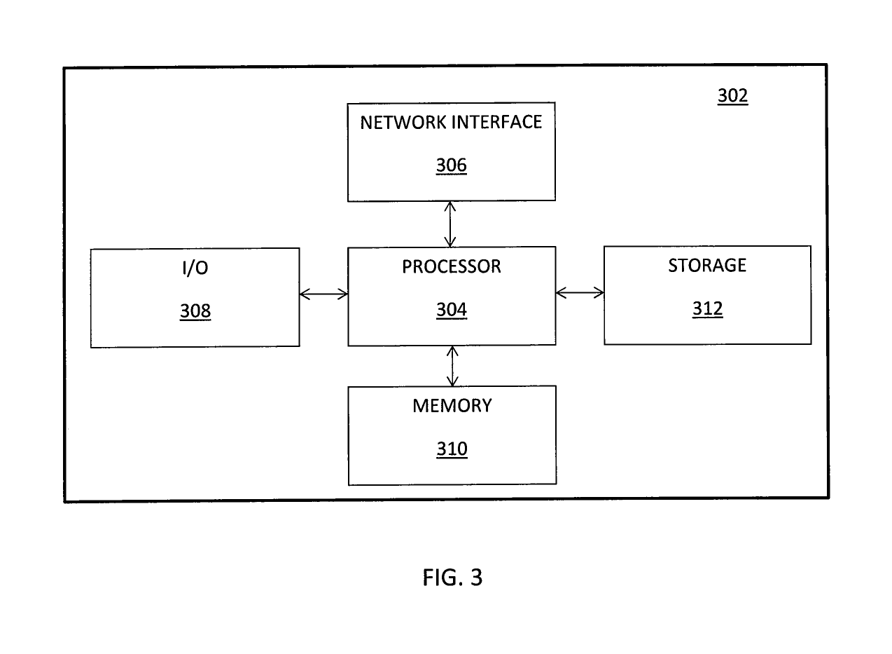

Mobile user device 102, personal computer 104, and server 108 can each be implemented using a computer. A high-level block diagram of such a computer is illustrated in FIG. 3. Computer 302 contains a processor 304 which controls the overall operation of the computer 302 by executing computer program instructions which define such operation. The computer program instructions may be stored in a storage device 312, or other computer readable medium (e.g., magnetic disk, CD ROM, etc.), and loaded into memory 310 when execution of the computer program instructions is desired. Thus, the method steps of FIGS. 2A and 2B can be defined by the computer program instructions stored in the memory 310 and/or storage 312 and controlled by the processor 304 executing the computer program instructions. For example, the computer program instructions can be implemented as computer executable code programmed by one skilled in the art to perform an algorithm defined by the method steps of FIGS. 2A and 2B. Accordingly, by executing the computer program instructions, the processor 304 executes an algorithm defined by the method steps of FIGS. 2A and 2B. The computer 302 also includes one or more network interfaces 306 for communicating with other devices via a network. The computer 302 also includes input/output devices 308 that enable user interaction with the computer 302 (e.g., display, keyboard, mouse, speakers, buttons, etc.) One skilled in the art will recognize that an implementation of an actual computer could contain other components as well, and that FIG. 3 is a high level representation of some of the components of such a computer for illustrative purposes.

The foregoing Detailed Description is to be understood as being in every respect illustrative and exemplary, but not restrictive, and the scope of the inventive concept disclosed herein is not to be determined from the Detailed Description, but rather from the claims as interpreted according to the full breadth permitted by the patent laws. It is to be understood that the embodiments shown and described herein are only illustrative of the principles of the inventive concept and that various modifications may be implemented by those skilled in the art without departing from the scope and spirit of the inventive concept. Those skilled in the art could implement various other feature combinations without departing from the scope and spirit of the inventive concept.

1. A method for a social gaming storefront comprising:
receiving a user request to play a game;
presenting the user with a branded game that can be played in response to the user request to play a game;
receiving user input selecting to play the branded game;
presenting the selected branded game to the user to play in response to the user input selecting to play the branded game;
tracking user play; and
awarding a reward to the user related to a brand of the selected branded game based on the tracking.

2. The method of claim 1 further comprising:
receiving user input requesting a purchase using reward points the user has accumulated; and
facilitating the purchase; and
decreasing an amount of the user's reward points based on the purchase.

3. The method of claim 1 further comprising:
receiving user input indicating that the user is requesting to play a round of the selected branded game;
decreasing an amount of play chips the user has in response to initiating a round of the selected branded game; and
awarding play chips to the user based on game play.

4. The method of claim 1 further comprising:
randomly presenting the user with a bonus icon; and
banking the bonus icon in response to user input.

5. The method of claim 4 further comprising:
receiving user input requesting a purchase using a plurality of banked bonus icons;
facilitating the purchase; and
decreasing an amount of the user's banked bonus icons based on the purchase.

6. The method of claim 1 further comprising:
receiving a user request to purchase play chips; and
adding a number of play chips to a user's account in response to the request, the number of play chips added to a user's account based on a dollar amount specified by the user.

7. The method of claim 1 further comprising:
adding a plurality of reward points to a user account in response to a purchase from a business associated with a branded game.

8. The method of claim 1 further comprising:
posting game play information to a website associated with the user, the game play information based on the tracking.

9. The method of claim 1, the presenting the selected branded game to the user comprises:
presenting a link to a website of an entity associated with the selected branded game, wherein branding of the selected branded game is related to the entity.

10. An apparatus comprising:
a processor; and
a memory to store computer program instructions, the computer program instructions when executed on the processor cause the processor to perform operations comprising:
receiving a user request to play a game;
presenting the user with a branded game that can be played in response to the user request to play a game;
receiving user input selecting to play the branded game;
presenting the selected branded game to the user to play in response to the user input selecting to play the branded game;
tracking user play; and
awarding a reward to the user related to a brand of the selected branded game based on the tracking.

11. The apparatus of claim 10, the operations further comprising:
receiving user input requesting a purchase using reward points the user has accumulated; and
facilitating the purchase; and
decreasing an amount of the user's reward points based on the purchase.

12. The apparatus of claim 10, the operations further comprising:
receiving user input indicating that the user is requesting to play a round of the selected branded game;
decreasing an amount of play chips the user has in response to initiating a round of the selected branded game; and
awarding play chips to the user based on game play.

13. The apparatus of claim 10, the operations further comprising:
randomly presenting the user with a bonus icon; and
banking the bonus icon in response to user input.

14. The apparatus of claim 13, the operations further comprising:
receiving user input requesting a purchase using a plurality of banked bonus icons;
facilitating the purchase; and
decreasing an amount of the user's banked bonus icons based on the purchase.

15. The apparatus of claim 10, the operations further comprising:
receiving a user request to purchase play chips; and
adding a number of play chips to a user's account in response to the request, the number of play chips added to a user's account based on a dollar amount specified by the user.

16. The apparatus of claim 10, the operations further comprising:
adding a plurality of reward points to a user account in response to a purchase from a business associated with a branded game.

17. The apparatus of claim 10, the operations further comprising:
posting game play information to a website associated with the user, the game play information based on the tracking.

18. The apparatus of claim 10, the presenting the selected branded game to the user comprises:
presenting a link to a website of an entity associated with the selected branded game, wherein branding of the selected branded game is related to the entity.

19. A computer readable medium storing computer program instructions, which, when executed on a processor, cause the processor to perform operations comprising:
receiving a user request to play a game;
presenting the user with a branded game that can be played in response to the user request to play a game;
receiving user input selecting to play the branded game;
presenting the selected branded game to the user to play in response to the user input selecting to play the branded game;
tracking user play; and
awarding a reward to the user related to a brand of the selected branded game based on the tracking.

20. The computer readable medium of claim 19, the operations further comprising:
receiving user input requesting a purchase using reward points the user has accumulated; and
facilitating the purchase; and
decreasing an amount of the user's reward points based on the purchase.

21. The computer readable medium of claim 19, the operations further comprising:
receiving user input indicating that the user is requesting to play a round of the selected branded game;
decreasing an amount of play chips the user has in response to initiating a round of the selected branded game; and
awarding play chips to the user based on game play.

22. The computer readable medium of claim 19, the operations further comprising:
randomly presenting the user with a bonus icon; and
banking the bonus icon in response to user input.

23. The computer readable medium of claim 22, the operations further comprising:
receiving user input requesting a purchase using a plurality of banked bonus icons;
facilitating the purchase; and
decreasing an amount of the user's banked bonus icons based on the purchase.

24. The computer readable medium of claim 19, the operations further comprising:
receiving a user request to purchase play chips; and
adding a number of play chips to a user's account in response to the request, the number of play chips added to a user's account based on a dollar amount specified by the user.

25. The computer readable medium of claim 19, the operations further comprising:
adding a plurality of reward points to a user account in response to a purchase from a business associated with a branded game.

26. The computer readable medium of claim 19, the operations further comprising:
posting game play information to a website associated with the user, the game play information based on the tracking.

27. The computer readable medium of claim 19, the operations further comprising:
presenting a link to a website of an entity associated with the selected branded game, wherein branding of the selected branded game is related to the entity.
